(19) United States
(12) Patent Application Publication
(10) Pub. No.: US 2007/0079177 A1
(43) Pub. Date: Apr. 5, 2007

(54) Process monitoring and diagnosis apparatus, systems, and methods

(76) Inventors: Charles Spirakis, Los Altos, CA (US); David Levinthal, Portland, OR (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/241,239

(22) Filed: Sep. 30, 2005

(51) Int. Cl. G06F 11/00

(52) U.S. Cl. 714/34

(57) ABSTRACT

Apparatus, systems, methods, and articles may operate to create a performance breakpoint upon detecting a performance event using a breakpoint intercept module. These activities may occur in an environment used to diagnose a watched process. A diagnostic function may be performed upon an occurrence of the performance breakpoint. Other embodiments are described and claimed.

### TECHICAL FIELD

Various embodiments described herein relate to computing systems generally, including apparatus, systems, and methods used to diagnose a watched process.

### BACKGROUND INFORMATION

Software development tools may include traditional code assemblers, compilers, interpreters and debuggers. These tools may enable a code developer to set “breakpoints” in a software process execution stream. Execution of the process may halt at a breakpoint to allow the developer to examine contents of registers and memory locations and to check values of variables, counters, and indices. Modem processor architectures may include combinations of pipelined, parallel pipelined, and multiprocessor systems. These systems may interact with software environments in complex ways not anticipated by traditional development tools. Software development for these new architectures may benefit from higher-performance diagnostic techniques.

### BRIEF DESCRIPTION OF THE DRAWINGS

FIG. 1 is a block diagram of an apparatus and a representative system according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

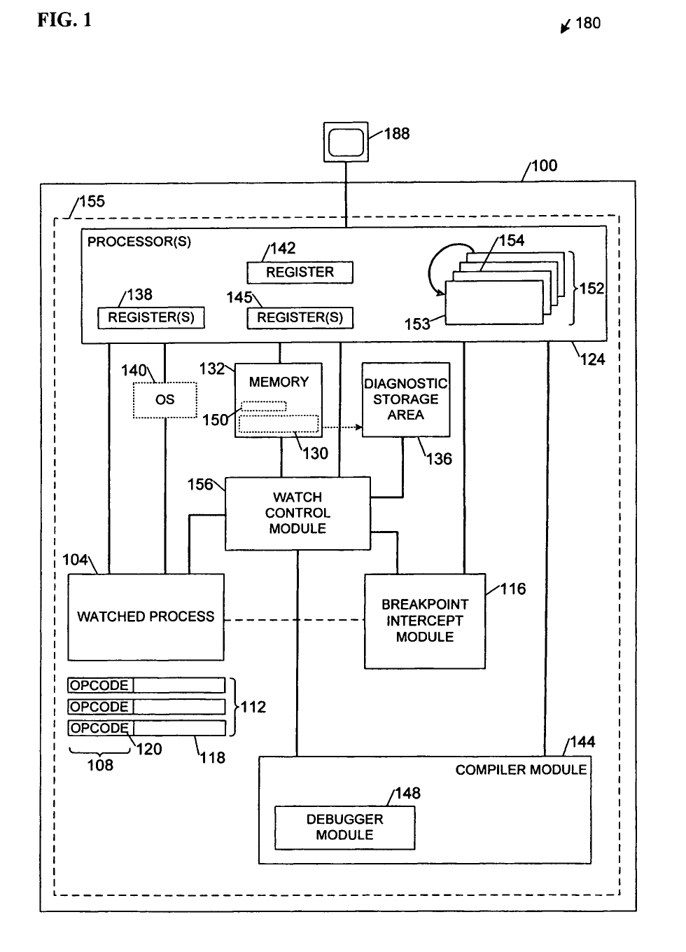

FIG. 1 comprises a block diagram of an apparatus 100 and a system 180 according to various embodiments of the invention. A watched process 104 may comprise an application to be diagnosed. The watched process 104 may include a set of opcodes 108 associated with a set of instructions 112 to be executed. A breakpoint intercept module 116 may create a performance breakpoint upon detecting a performance event. A performance event is a hardware or software state related to a system architectural structure. These may include states or state changes countable by a processor. Examples of performance events may include execution of a particular opcode, a number of processor cycles of a particular type expended, a number of instructions of a particular type retired, a pattern match against instruction or data streams associated with the watched process 104, or an occurrence of an L3 cache miss, among others.

Embodiments of the invention may selectively perform diagnostic activity upon an occurrence of the performance event. Thus, for example, diagnostic activity may commence when an agreed-upon instruction 118 associated with an opcode 120 from the watched process 104 is executed by a processor 124. An insertion of the agreed-upon instruction 118 or of the opcode 120 into an instruction stream may be accomplished thgrough a compiler or with a mechanism of binary instrumentation. An observance of the agreed-upon instruction by the breakpoint intercept module may comprise a communication of an action to be taken. The watched process 104 may be capable of inserting breakpoints without recompilation, since diagnostic activities may be enabled and disabled at the breakpoint intercept module 116. It is noted that “execution of an opcode” or like phrase may be used herein to mean execution of an instruction associated with the opcode.

Examples of diagnostic activities may include copying contents of portions 130 of a memory 132 accessed by or referred to by the watched process 104. The copied contents 130 may be saved to an agreed-upon diagnostic storage area 136 for later analysis. Contents of one or more registers 138 or states related to systems, chipsets, or processors may also be saved for later analysis.

Embodiments of the invention may be useful for performance analysis. Disclosed methods may be less intrusive on the watched process 104 than would be the case if the watched process 104 performed the diagnostic activity itself. For example, the breakpoint intercept module 116 may statistically sample streams of data or instructions associated with the watched process 104. It may be difficult to accomplish such computationally-intensive diagnostic tasks using the watched process 104 without impacting a performance of the watched process 104.

Some embodiments may be capable of performing the diagnostic activities without intervention of an operating system (OS) 140, or may be OS-independent. The breakpoint intercept module 116 may be loaded dynamically, and may operate cooperatively with the watched process 104. Information not easily captured by either entity alone may be effectively trapped thereby. Generating performance breakpoints and performing diagnostic activities in response thereto may operate to flexibly associate the watched process 104 with diagnostic collection abilities associated with the breakpoint interface module 116.

The watched process 104 may select opcodes against which the breakpoint intercept module 116 may later match to initiate the diagnostic activities. In some embodiments, the selected opcode may perform operations in addition to the diagnostic activities. A move instruction from the watched process 104 may, for example, comprise an agreed-upon diagnostic command to the breakpoint intercept module 116. The move instruction may also perform an actual move operation integral to the watched process 104. This may differ from a hardware-defined opcode designed to force an interrupt (e.g., a “sysenter” or “int NN” instruction). Alternatively, a special opcode that is effectively a no-op may be used to minimize performance impact during times when the diagnostic activities are not being performed.

In some embodiments, diagnostic activities may be mapped to ranges of opcodes being watched or to operands in instructions associated with the opcodes. The breakpoint intercept module 116 may be configured to trigger on a group of opcodes (e.g., all “mov r27=XXX” instructions). When the breakpoint interface module 116 determines that a particular one of the opcodes in the group was executed, the breakpoint interface module 116 may take specific action based on the particular opcode. A “mov r27=r27” may, for example, indicate to the breakpoint interface module 116 that the watched process 104 wishes to save the contents of the register(s) 138 to the diagnostic storage area 136. The register(s) 138 may comprise a current register set. In another example, a “mov r27=r31” may indicate that the contents of the register(s) 138 should be saved to an address indicated by the contents of r31. In a further example, a “mov r27=r30, 8” may indicate that eight bytes of memory pointed to by the contents of r30 should be saved to the diagnostic storage area 136.

Some embodiments may assign a register 142 to store a value indicative of a desired diagnostic activity during the execution of the watched process 104. This mechanism may provide flexibility for a compiler 144 comprising embodiments of the invention to select one or more registers 145 in which to store data to be collected for the diagnostic activities.

The watched process 104 may thus pass opcodes and register values as parameters to the breakpoint intercept module 116 to specify the diagnostic activities. An opcode group may trigger the start of diagnostic activities, and a particular opcode selected from the group may indicate which diagnostic activities to perform.

In some embodiment of the invention, the breakpoint intercept module 116 may interact with a debugger module 148 upon sensing a performance breakpoint. This capability may enhance the breakpoint intercept module 116, the debugger 148, or both. A programmer may, for example, observe that the watched process 104 is failing in an unusual way, but that the failure is rare. The programmer may define a performance breakpoint, perhaps using a pattern match facility as previously described. The breakpoint intercept module 116 may watch a value contained in a memory location 150 or contained in the register(s) 138 and may generate a performance breakpoint when the failure occurs. The breakpoint intercept module 116 may also count a number of times the performance breakpoint occurs, and generate a break into the debugger module 148 at a preset count. This facility may enable breakpoints to be triggered based upon code path frequency instead of triggering at every code path encounter.

Thus, embodiments of the invention may use address filters, data filters, or data location filters, among others, to precisely define a performance breakpoint. The breakpoint interface module 116 may utilize additional criteria to decide whether to generate a traditional breakpoint into the debugger module 148. A breakpoint may thus be triggered based upon a complex set of criteria. As an example, the criteria may include a quantity of stores retired instructions used by a particular procedure or fetched from a first address range, wherein the stores retired instructions may have read from a second address range.

These embodiments may permit breaking when the watched register(s) 138 contain particular values, without waiting until the values are written to memory. The breakpoint intercept module 116 may break based upon an occurrence of a particular type of instruction (e.g., move instructions that involve the watched register(s) 138). The breakpoint intercept module 116 may then break into the debugger module 148 when the watched register(s) 138 contain out-of-range values. This may allow a programmer to observe an out-of-range condition before an out-of-range value is written to memory, without single-stepping through the program. Trapping on opcodes that write to the watched register(s) 138 may thus enable the capture of timing-sensitive bugs that might otherwise go undetected during single-step debugging.

Some embodiments may utilize a rotating register 152, performance breakpoint mechanisms, and the ability to break into a debugger to create an enhanced diagnostic environment. The environment may provide visibility into software pipeline execution. The environment may also be used to capture a history of register values in real time during execution.

A software pipeline may use the rotating register 152 to store values resulting from iterations of a software loop. After each iteration of the software loop, a value stored in a first register position 153 associated with the rotating register 152 during a previous iteration may be found in a second register position 154. It may be difficult to determine the iteration, register position, and register value responsible for an incorrect result in the watched process 104. The breakpoint interface module 116 may use performance breakpoints to determine when the pipeline is in a particular state (e.g., first time full, last time full, etc.). The breakpoint interface module 116 may then cause a debug breakpoint to be generated.

A programmer may also use the rotating register 152 to watch values associated with the watched register(s) 138 over time to create a register history. The breakpoint interface module 116 may cause a performance breakpoint when the register history is full. That is, a performance breakpoint may be generated after a number of register writes equal to a depth of the rotating register 152. This mechanism may enable the breakpoint intercept module 116 to capture and record a statistically sampled, historical sequence of register values. The mechanism may avoid single-stepping the application and possibly losing diagnostic information associated with real-time execution.

The apparatus 100 may thus include a watched process 104 used to select a preselected processor opcode 120. The breakpoint intercept module 116 may be coupled to the watched process 104 to create a performance breakpoint. The performance breakpoint may be created upon detecting a performance event in an environment 155 used to diagnose the watched process 104.

The apparatus 100 may also include a watch control module 156 to couple to the watched process 104 and to the breakpoint intercept module 116. The watch control module 156 may enable a configuration of the environment 155 and may perform a diagnostic function upon an occurrence of the performance breakpoint. A debugger module 148 may be coupled to the watch control module 156 to perform a breakpoint operation, as previously described.

The apparatus 100 may further include a diagnostic storage area 136 coupled to the watch control module 156. The diagnostic storage area 136 may store diagnostic information gathered while performing the diagnostic function.

In another embodiment, a system 180 may include one or more of the apparatus 100, including a watched process 104 and a breakpoint intercept module 116, among other elements as previously described. The system 180 may also include one or more processors 124 coupled to the watched process 104. The processor(s) 124 may execute instructions associated with the watched process 104. The system 180 may further include a display 188 coupled to the processor 124 to display information related to the watched process 104. The display 188 may comprise a cathode ray tube display, or a solid-state display such as a liquid crystal display, a plasma display, or a light-emitting diode display, among others.

The system 180 may further include one or more registers 138 within the processor(s) 124 to be watched as contents of the register(s) 138 are manipulated by the watched process 104. A rotating register 152 within the processor 124 may be used to store a history of a performance event over time. The rotating register 152 may also be used to store a series of intermediate pipeline results, as previously described.

Any of the components previously described can be implemented in a number of ways, including embodiments in software. Thus, the apparatus 100; watched process 104; opcodes 108, 120; instructions 112; 118; breakpoint intercept module 116; processor 124; memory portion 130; memory 132; storage area 136; registers 138, 142, 145; operating system (OS) 140; compiler 144; debugger module 148; memory location 150; rotating register 152; register positions 153, 154; environment 155; watch control module 156; system 180; and display 188 may all be characterized as “modules” herein.

The modules may include hardware circuitry, single or multi-processor circuits, memory circuits, software program modules and objects, firmware, and combinations thereof, as desired by the architect of the apparatus 100 and system 180 and as appropriate for particular implementations of various embodiments. The apparatus and systems described herein may be used in applications other than detecting performance events using a breakpoint intercept module and creating performance breakpoints for diagnostic purposes. The apparatus 100 and the system 180 comprise examples intended to provide a general understanding of the structure of various embodiments. Other combinations may be possible.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, and others. Some embodiments may include a number of methods.

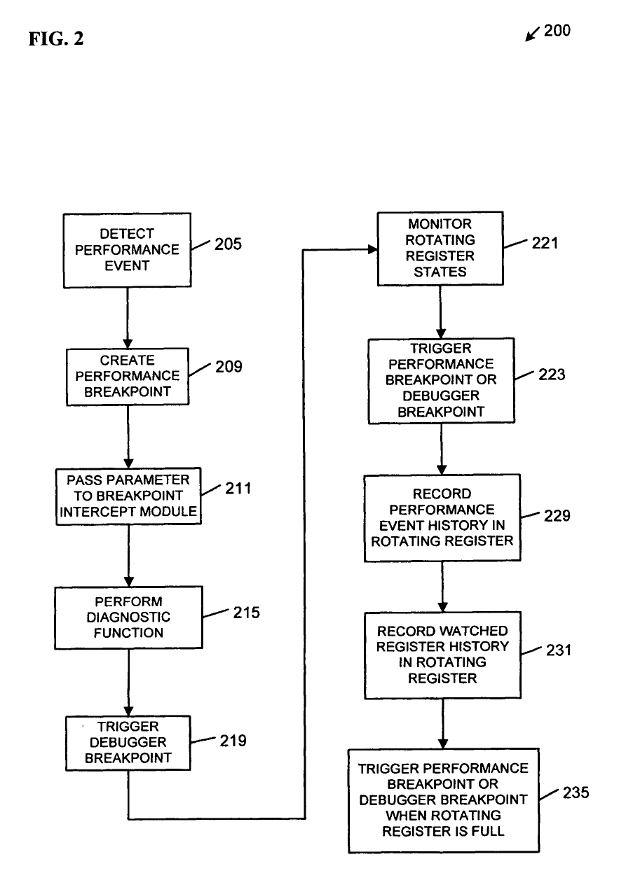

FIG. 2 is a flow diagram representation illustrating several methods according to various embodiments of the invention. A method 200 may begin at block 205 with detecting a performance event using a breakpoint intercept module. The performance event may be associated with a watched process to be diagnosed. The method 200 may continue at block 209 with creating a performance breakpoint upon detecting the performance event.

The performance event may comprise an execution of a preselected processor opcode, including perhaps an opcode associated with the watched process to be diagnosed. Other performance events may include pattern matches within a stream of instructions comprising the watched process or within a stream of data manipulated by the watched process. Additional performance events may include a number of instructions retired or a number of a particular type of instructions retired. Performance events may also include a number of processor cycles expended or a number of processor cycles of a particular type expended. An L3 cache miss may comprise a performance event.

The method 200 may also include passing a parameter between the watched process and the breakpoint intercept module, the parameter to indicate a diagnostic function to be performed, at block 211. The method 200 may continue at block 215 with performing a diagnostic function upon an occurrence of the performance breakpoint. It is noted that in some embodiments, an execution of the preselected processor opcode may result in no action other than performing the diagnostic function. Alternatively, the preselected opcode may cause execution of a traditional, non-diagnostic function in addition to triggering the diagnostic function, as previously described.

The diagnostic function to be performed may comprise saving a portion of an environment associated with the watched process for analysis, invoking a debugger, or both. The portion of the environment to be saved may comprise one or more of a memory area, a processor state, a chipset state, and a software state. The portion of the environment to be saved, the diagnostic function to be performed, or both may be indicated by a particular opcode selected from a range of opcodes or by an operand in an instruction executed using the particular opcode. Other indicators may include a value of a register named in the operand, a bit pattern set in the register, and a value of a memory location referenced in the register.

The method 200 may further include selectively triggering a breakpoint in the debugger, at block 219. The debugger breakpoint may be triggered upon an occurrence of the performance breakpoint, or upon detecting an error in the watched process. The error in the watched process may comprise an out-of-limit value in a selected memory location, an out-of-limit value in a selected register, or both. The debugger breakpoint may also be triggered upon detecting that the preselected processor opcode has executed a selected number of times, or upon reaching a predetermined count using a code path frequency counter. In some embodiments, the debugger breakpoint may be triggered upon detecting a match using an address filter, a data location filter, or both.

The method 200 may include monitoring a series of states associated with a rotating register, at block 221. The rotating register may be used in a software pipeline application. The performance breakpoint, the debugger breakpoint, or both may be triggered when the rotating register reaches a predetermined state, at block 223. The rotating register may also be used to record a history of a performance event over a period of time or over a number of iterations, at block 229. A history of a watched register may be created by storing a contents of the watched register in the rotating register at a time when the watched register is written to, at block 231. The method 200 may conclude at block 235 with triggering a performance breakpoint or a debugger breakpoint when the rotating register has been written to a number of times equal to a depth of the rotating register.

It may be possible to execute the activities described herein in an order other than the order described. And, various activities described with respect to the methods identified herein may be executed in repetitive, serial, or parallel fashion.

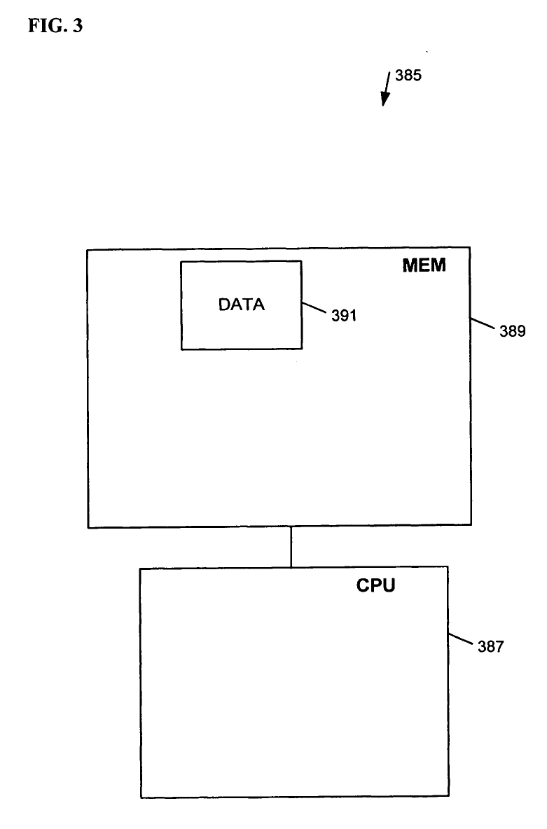

A software program may be launched from a computer-readable medium in a computer-based system to execute functions defined in the software program. Various programming languages may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment. Thus, other embodiments may be realized, as discussed regarding FIG. 3 below.

FIG. 3 is a block diagram of an article 385 according to various embodiments of the invention. Examples of such embodiments may comprise a computer, a memory system, a magnetic or optical disk, some other storage device, or any type of electronic device or system. The article 385 may include one or more processor(s) such as a central processing unit (CPU) 387 coupled to a machine-accessible medium such as a memory 389 (e.g., a memory including electrical, optical, or electromagnetic elements). The medium may contain associated information 391 (e.g., computer program instructions, data, or both) which, when accessed, results in a machine (e.g., the CPU 387) performing the activities previously described.

Implementing the apparatus, systems, and methods disclosed herein may utilize a breakpoint intercept module to interact cooperatively with a process to be diagnosed. The breakpoint intercept module may receive parameters from the process to indicate which data, instructions, or states to capture. The parameters may also indicate when to perform the capture and where to store the results. Generating performance breakpoints and performing diagnostic activities in response thereto may result in an enhanced diagnostic environment.

Embodiments of the present invention may be implemented as part of a wired or wireless system. Examples may also include embodiments comprising multi-carrier wireless communication channels (e.g., OFDM, DMT, etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A method, including:
creating a performance breakpoint upon detecting a performance event using a breakpoint intercept module in an environment used to diagnose a watched process; and
performing a diagnostic function upon an occurrence of the performance breakpoint.

2. The method of claim 1, wherein the performance event comprises an execution of a preselected processor opcode

3. The method of claim 2, wherein the preselected processor opcode triggers no processor action other than performing the diagnostic function.

4. The method of claim 1, wherein the performance event includes at least one of a pattern match within a stream of instructions comprising the watched process, a pattern match within a stream of data manipulated by the watched process, a number of instructions retired, a number of a particular type of instructions retired, a number of processor cycles expended, a number of processor cycles of a particular type expended, and an L3 cache miss.

5. The method of claim 1, wherein the diagnostic function comprises at least one of saving a portion of an environment associated with the watched process for analysis and invoking a debugger.

6. The method of claim 5, wherein the portion of the environment comprises at least one of a memory area, a processor state, a chipset state, and a software state.

7. The method of claim 5, wherein the portion of the environment corresponds to at least one of a particular opcode selected from a range of opcodes, an operand in an instruction executed using the particular opcode, a value of a register named in the operand, a bit pattern set in the register, and a value of a memory location referenced in the register.

8. The method of claim 1, wherein the diagnostic function to be performed corresponds to at least one of a particular opcode selected from a range of opcodes, an operand in an instruction executed using the particular opcode, a value of a register named in the operand, a bit pattern set in the register, and a value of a memory location referenced in the register.

9. The method of claim 1, further including:
passing a parameter between the watched process and the breakpoint intercept module, the parameter to indicate the diagnostic function to be performed.

10. The method of claim 1, further including:
selectively triggering a breakpoint in a debugger upon the occurrence of the performance breakpoint.

11. The method of claim 1, further including:
selectively triggering a breakpoint in a debugger upon detecting an error in the watched process.

12. The method of claim 11, wherein the error in the watched process comprises at least one of an out-of-limit value in a selected memory location and an out-of-limit value in a selected register.

13. The method of claim 1, further including:
selectively triggering a breakpoint in a debugger upon detecting that a preselected processor opcode has executed a selected number of times.

14. The method of claim 1, further including:
selectively triggering a breakpoint in a debugger upon reaching a predetermined count in a code path frequency counter.

15. The method of claim 10, further including:
selectively triggering a breakpoint in a debugger upon detecting a match using at least one of an address filter and a data location filter.

16. The method of claim 1, further including:
monitoring a series of states associated with a rotating register; and
triggering at least one of the performance breakpoint and a debugger breakpoint when the rotating register reaches a predetermined state.

17. The method of claim 16, further including:
using the rotating register in a software pipeline application.

18. The method of claim 1, further including:
recording a history of the performance event in a rotating register over at least one of a period of time and a number of iterations.

19. The method of claim 1, further including:
creating a history of a watched register by storing a contents of the watched register in a rotating register at a time when the watched register is written to; and
triggering at least one of the performance breakpoint and a debugger breakpoint when the rotating register has been written to a number of times equal to a depth of the rotating register.

20. An article including a machine-accessible medium having associated information, wherein the information, when accessed, results in a machine performing:
creating a performance breakpoint upon detecting a performance event using a breakpoint intercept module in an environment used to diagnose a watched process; and
performing a diagnostic function upon an occurrence of the performance breakpoint.

21. The article of claim 20, wherein the performance event comprises an execution of a preselected processor opcode.

22. The article of claim 20, wherein the performance event includes at least one of a pattern match within a stream of instructions comprising the watched process, a pattern match within a stream of data manipulated by the watched process, a number of instructions retired, a number of a particular type of instructions retired, a number of processor cycles expended, a number of processor cycles of a particular type expended, and an L3 cache miss.

23. An apparatus, including:
a breakpoint intercept module to create a performance breakpoint upon detecting a performance event in an environment used to diagnose a watched process; and
a watch control module to couple to the watched process and to the breakpoint intercept module to enable configuration of the environment used to diagnose the watched process and to perform a diagnostic function upon an occurrence of the performance breakpoint.

24. The apparatus of claim 23, further including:
a diagnostic storage area coupled to the watch control module to store diagnostic information gathered while performing the diagnostic function.

25. The apparatus of claim 23, further including:
a debugger module to couple to the watch control module to perform a breakpoint operation.

26. A system, including:
a breakpoint intercept module to create a performance breakpoint upon detecting a performance event in an environment used to diagnose a watched process;
a watch control module to couple to the watched process and to the breakpoint intercept module to enable configuration of the environment used to diagnose the watched process and to perform a diagnostic function upon an occurrence of the performance breakpoint;
a processor coupled to the watched process to execute instructions associated with the watched process; and
a display coupled to the processor to display information related to the watched process.

27. The system of claim 26, further including:
a register within the processor to be watched as contents of the register are manipulated by the watched process.

28. The system of claim 26, further including:
a rotating register within the processor used to store at least one of a history of a performance event over time and a series of intermediate pipeline results.
